(19) United States
(12) Patent Application Publication
(10) Pub. No.: US 2004/0209667 A1
(43) Pub. Date: Oct. 21, 2004

(54) Gaming machine

(76) Inventors: Kazuki Emori, Tokyo (JP); Shingo Omomo, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/697,026

(22) Filed: Oct. 31, 2003

(30) Foreign Application Priority Data
Nov. 18, 2002 (JP) 2002-334121

(51) Int. Cl. A63F 13/00

(52) U.S. Cl. 463/20

(57) ABSTRACT

With liquid crystal provided in front of reels, a gaming machine includes a plurality of reel belts 340 each on which a plurality of symbols are placed, a plurality of reel wheels 330 to which the symbol strips are attached annularly, liquid crystal 504 provided in front of the reel wheels 330 for displaying an image concerning game play, and reel backlights 513 for illuminating the symbols from behind the symbols. The reel wheels 330 are made transparent or semitransparent for transmitting light from the reel backlights 513 in the direction of the liquid crystal 504. The shadow of the reel is not cast over an image, enabling the player to clearly visually check the essential image.

### BACKGROUND OF THE INVENTION

1. Field of the Invention

The present invention relates to a gaming machine including a liquid crystal display.

2. Description of the Related Art

A recent slot machine including stop buttons or a pinball slot machine (a so-called “Pachi-Slot machine” in Japan) has a variable display means provided with a plurality of rotation reels for variably displaying symbols in a front display window. As the player performs start operation, control means controls the variable display means for rotating the reels, thereby variably displaying symbols. Then, the rotating reels are stopped in order automatically in a given time or as the player performs stop operation. At this time, if the symbols on the reels appearing in the display window become a specific combination (winning symbol combination), game medium such as medals or coins are paid out to the player as the prize of the win.

The currently predominant pinball slot machine has a display window for the player to visually check symbols on reels on the front of the machine and a liquid crystal display for displaying an effect image concerning game play on a side of, below, or above the display window (namely, a position not overlapping the display window from the viewpoint of the player). Such a liquid crystal display generally is provided with a liquid crystal backlight implemented as a cold-cathode tube for producing sharp display.

Generally, reel backlights implemented as white light emitting diodes are provided for illuminating the symbols on the reel belts from behind to project the symbols onto the display windows.

A reel wheel around which the reel belt is wound generally uses a member having a black surface, and the reel wheel and the reel belt are distinguished from each other in visual observation.

The structure described above is disclosed in JP-A-2001-353255 (see page 3; and FIG. 5).

### SUMMARY OF THE INVENTION

However, if an attempt is made to dispose the liquid crystal display so that a part of the liquid crystal display overlaps the display window, the reel representing the symbols exists just behind the display window and no liquid crystal backlight can be provided in the portion of the display window of the liquid crystal display and thus a reel backlight for illuminating the symbols on the reel from behind is used supplementally as a liquid crystal backlight. The reel wheel blocks light of the reel backlight, a shadow of the reel wheel is cast over the image. Therefore, there occurs a problem that the image in the portion over which the shadow is cast does not develop color, the view of the player who visually checks the image on liquid crystal is obstructed, and the player cannot clearly visually check and recognize the essential image.

It is an object of the invention to provide a gaming machine for making it possible to prevent the shadow of each reel from being cast over an image and enabling the player to clearly visually check the essentially image and enjoy playing a game.

According to one aspect of the invention, there is provided a gaming machine including: a plurality of symbol strips (for example, reel belts 340) each having a plurality of symbols; a plurality of annular bodies (for example, reel wheels 330, particularly rims 330a and 330b, any other body to which the symbol strip is attached annularly) to which each of the symbol strips are annularly attached; image display means (for example, liquid crystal 504) provided in front of the plurality of annular bodies and configured to display an image concerning a game, and a light source (for example, reel backlights 513) configured to illuminate the symbols from behind the symbols, wherein the plurality of annular bodies are made transparent or semitransparent for transmitting light from the light source in the direction of the image display means.

According to the configuration, the light from the light source passes through the annular body and arrives at the image display means, so that an image is sharply displayed even at a position where the shadow of the annular body is cast; the shadow of the annular body is not cast over the image, enabling the player to clearly visually check the image and enjoy playing a game.

According to another aspect of the invention, there is provided a gaming machine including: a plurality of symbol strips (for example, reel belts 340) each having a plurality of symbols; a plurality of annular bodies (for example, reel wheels 330, particularly rims 330a and 330b, any other body to which the symbol strip is attached annularly) to which each of the symbol strips are annularly attached; image display means (for example, liquid crystal 504) provided in front of the plurality of annular bodies and configured to display an image concerning a game; and a light source (for example, reel backlights 513) configured to illuminate the symbols from behind the symbols, wherein the plurality of annular bodies are formed to diffuse light from the light source in the direction of the image display means.

According to the configuration, the light from the light source is diffused through the annular body and arrives at the image display means, so that an image is sharply displayed even at a position where the shadow of the annular body is cast, the shadow of the annular body is not cast over the image, and the light from the annular body is not highlighted either, enabling the player to clearly visually check the essential image and enjoy playing a game.

According to another aspect of the invention, there is provided a gaming machine including: a plurality of symbol strips (for example, reel belts 340) each having a plurality of symbols; a plurality of annular bodies (for example, reel wheels 330, particularly rims 330a and 330b, any other body to which the symbol strip is attached annularly) to which each of the symbol strips are annularly attached; image display means (for example, liquid crystal 504) provided in front of the plurality of annular bodies and configured to display an image concerning a game; and a light source (for example, fluorescent lamps 510) configured to illuminate the symbols from a slanting direction of a front of the symbols, wherein the plurality of annular bodies are formed to reflect light from the light source in the direction of the image display means.

According to the configuration, the light from the light source is reflected on the annular body and arrives at the image display means, so that an image is sharply displayed even at a position where the shadow of the annular body is cast, and the shadow of the annular body is not cast over the image, enabling the player to clearly visually check the image and enjoy playing a game.

According to another aspect of the invention, there is provided a gaming machine including: a plurality of annular bodies (for example, reels 3) each having an outer ring part (for example, rim 350e) on which a plurality of symbols are placed and an arm part (for example, arms 350c) joined to the outer ring part; image display means (for example, liquid crystal 504) provided in front of the plurality of annular bodies and configured to display an image concerning a game; and a light source (for example, reel backlights 513) configured to illuminate the symbols from behind the symbols, wherein the outer ring part and the arm part of each of the annular bodies (for example, reels 3) are formed in one piece, wherein at least a side margin of the outer ring part (for example, both side ends of outer peripheral surface 350f of rim 350e and nearby side margins 350a and 350b) is made transparent or semitransparent for transmitting light from the light source in a direction of the image display means.

According to the configuration, the light from the light source passes through the side margin of the annular body and arrives at the image display means, so that an image is sharply displayed even at a position where the shadow of the side margin of the annular body is cast, and the shadow of the side margin of the annular body is not cast over the image, enabling the player to clearly visually check the image and enjoy playing a game.

According to another aspect of the invention, there is provided a gaming machine including: a plurality of annular bodies (for example, reels 3) each having an outer ring part (for example, rim 350e) on which a plurality of symbols are placed, and an arm part (for example, arms 350c) joined to the outer ring part; image display means (for example, liquid crystal 504) provided in front of the plurality of annular bodies and configured to display an image concerning a game; and a light source (for example, reel backlights 513) configured to illuminate the symbols from behind the symbols, wherein the outer ring part and the arm part of each of the annular bodies (for example, reels 3) are formed in one piece, wherein at least a side margin of the outer ring part (for example, both side ends of outer peripheral surface 350f of rim 350e and nearby side margins 350a and 350b) is formed to diffuse light from the light source in a direction of the image display means.

According to the configuration, the light from the light source is diffused through the side margin of the annular body and arrives at the image display means, so that an image is sharply displayed even at a position where the shadow of the side margin of the annular body is cast, the shadow of the side margin of the annular body is not cast over the image, and the light from the side margin of the annular body is not highlighted either, enabling the player to clearly visually check the essential image and enjoy playing a game.

According to another aspect of the invention, there is provided a gaming machine including: a plurality of annular bodies (for example, reels 3) each having an outer ring part (for example, rim 350e) on which a plurality of symbols are placed, and an arm part (for example, arms 350c) joined to the outer ring part; image display means (for example, liquid crystal 504) provided in front of the plurality of annular bodies and configured to display an image concerning a game; and a light source (for example, fluorescent lamps 510) configured to illuminate the symbols from a slanting direction of a front of the symbols, wherein the outer ring part and the arm part of each of the annular bodies (for example, reels 3) are formed in one piece, wherein at least a side margin of the outer ring part (for example, both side ends of outer peripheral surface 350f of rim 350e and nearby side margins 350a and 350b) is formed to reflect light from the light source to diffuse in a direction of the image display means.

According to the configuration, the light from the light source is reflected on the side margin of the annular body and arrives at the image display means, so that an image is sharply displayed even at a position where the shadow of the side margin of the annular body is cast, and the shadow of the side margin of the annular body is not cast over the image, enabling the player to clearly visually check the image and enjoy playing a game.

The gaming machine of invention is characterized by the fact that the annular body is formed in white color.

According to the configuration, white allows the player to perceive color development of liquid crystal, so that the player can be prevented from perceiving the shadow of the annular body.

The gaming machine of invention is characterized by the fact that the annular body is formed of polycarbonate.

According to the configuration, transparency can be improved and the cost can be reduced.

### BRIEF DESCRIPTION OF THE DRAWINGS

In the accompanying drawings:

FIG. 1 is a drawing to show an embodiment of a gaming machine according to the invention and is a perspective view to show the appearance of a pinball slot machine as gaming machine;

FIG. 2 is a perspective view to show the appearance of the pinball slot machine with reels displayed in the embodiment of the gaming machine according to the invention;

FIG. 3 is a perspective view to show a reel means in first to third embodiments of the invention;

FIG. 4 is a perspective view to show a reel wheel and a reel belt making up a reel in the first to third embodiments of the invention;

FIG. 5 is a sectional view of the reel in the first to third embodiments of the invention;

FIG. 6 is a drawing to show symbol rows drawn on the outer peripheral surfaces of the reels in the first to third embodiments of the invention;

FIG. 7 is a drawing to show the reel, a liquid crystal display in front of the reel, and the reel side reflector in the first to third embodiments of the invention;

FIG. 8 is a drawing to show the reel and the liquid crystal display in front of the reel in the first to third embodiments of the invention;

FIG. 9 is a drawing to show the positional relationships among liquid crystal, the reels, the reel side reflectors, reel backlights, and a fluorescent lamp in the first to third embodiments of the invention;

FIG. 10 is a drawing to show the back of a door in the embodiment of the gaming machine according to the invention;

FIG. 11 is a block diagram to show the configuration of a main control circuit in the embodiment of the gaming machine according to the invention;

FIG. 12 is a block diagram to show the configuration of a sub-control circuit in the embodiment of the gaming machine according to the invention;

FIG. 13 is a perspective view to show a reel means in fourth to sixth embodiments of the invention;

FIG. 14 is a perspective view to show a reel in the fourth to sixth embodiments of the invention;

FIG. 15 is a sectional view of the reel in the in the fourth to sixth embodiments of the invention; and

FIG. 16 is a drawing to show the positional relationships among liquid crystal, the reels, reel side reflectors, reel backlights, and a fluorescent lamp in the fourth to sixth embodiments of the invention.

### DETAILED DESCRIPTION OF THE PREFERRED EMBODIMENTS

Referring now to the accompanying drawings, there are shown preferred embodiments of the invention.

First Embodiment

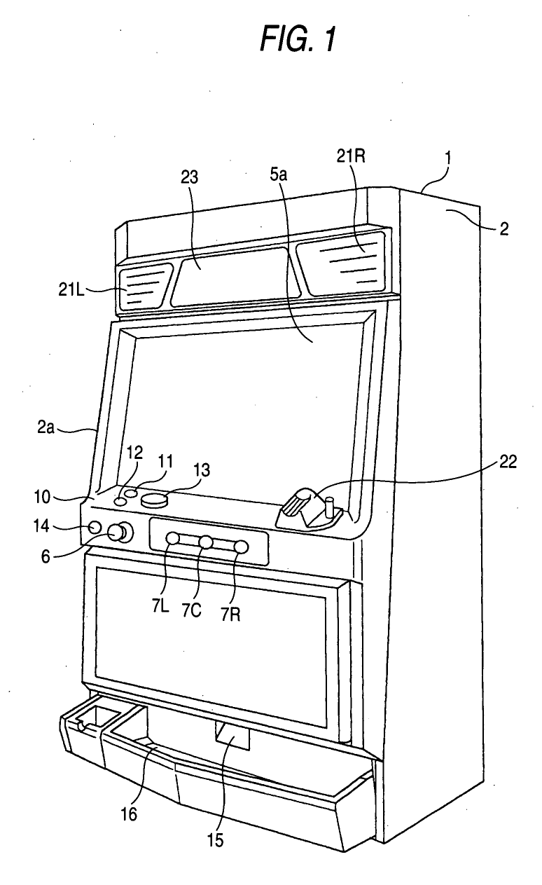

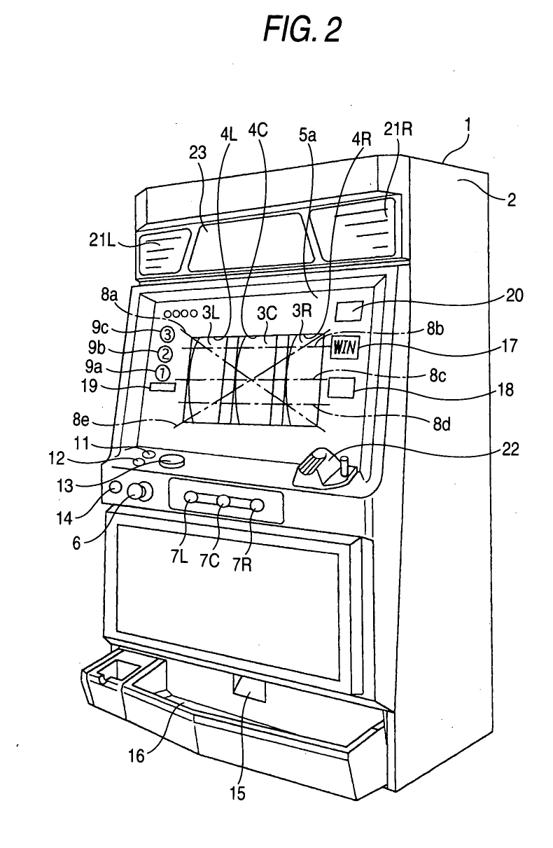

FIG. 1 shows a first embodiment applying a gaming machine according to the invention to a pinball slot machine (a so-called “Pachi-Slot machine” in Japan). FIG. 2 shows a state that a full screen display is not displayed by a liquid crystal display in display screen 5a and a member such as reels 3 disposed at the back of the liquid crystal are displayed through the display screen 5a.

A pinball slot machine 1 as a gaming machine is provided for the player to play a game using game medium such as a card storing information of the game play value given to the player as well as coins, medals and tokens. In the description that follows, it is assumed that the player uses medals.

In FIGS. 1 and 2, a panel display unit 2a roughly as a vertical plane is formed at the front of a cabinet 2 forming the whole of the pinball slot machine 1, and a liquid crystal display 5 (described later) having a rectangular 15-inch liquid crystal display screen 5a is provided on the front of the panel display unit 2a. An image can be displayed over the full face of the display screen 5a.

In the cabinet 2b, three reels (left reel 3L, center reel 3C, and right reel 3R) each with a symbol row including different types of symbols placed on the outer peripheral surface are provided in a row. The player can observe the symbols on the reels through the display windows 4L, 4C, and 4R. Each reel rotates at a constant speed (for example, 80 revolutions per minute).

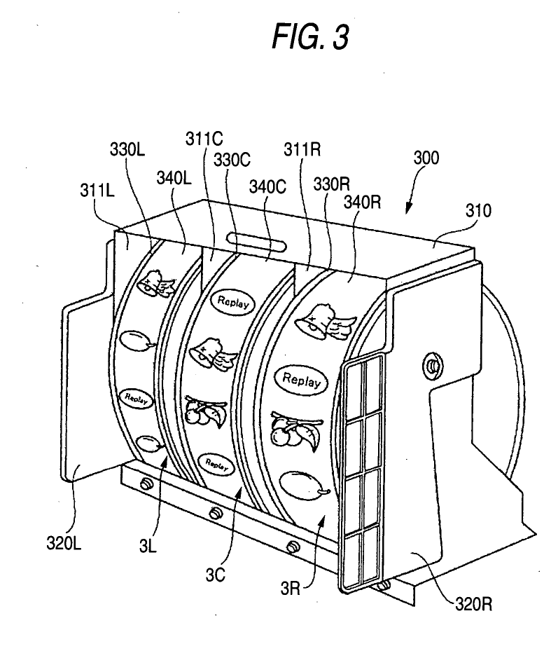

The three reels 3L, 3C, and 3R are housed in a reel case 310, as shown in FIG. 3. Reel side reflectors 320L and 320R each made of a while plate molded are attached to the sides of the reel case 310 so that they are positioned on the sides of the reel row 3L, 3C, 3R. The reels 3L, 3C, and 3R have annular reel belts 340L, 340C, and 340R attached to annular reel wheels 330L, 330C, and 330R attached to brackets 311L, 311C, and 311R for rotation.

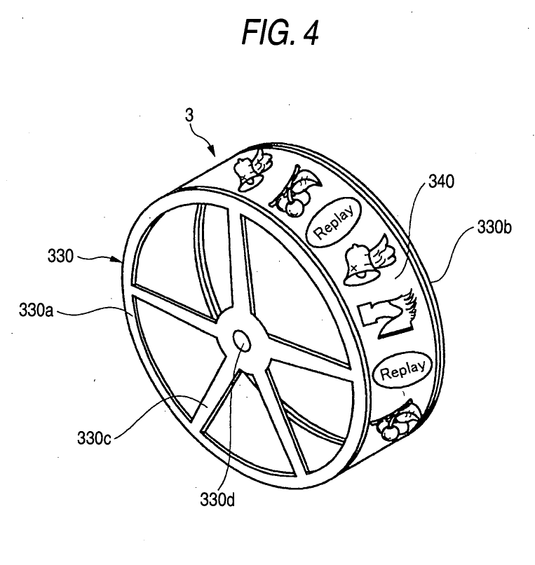

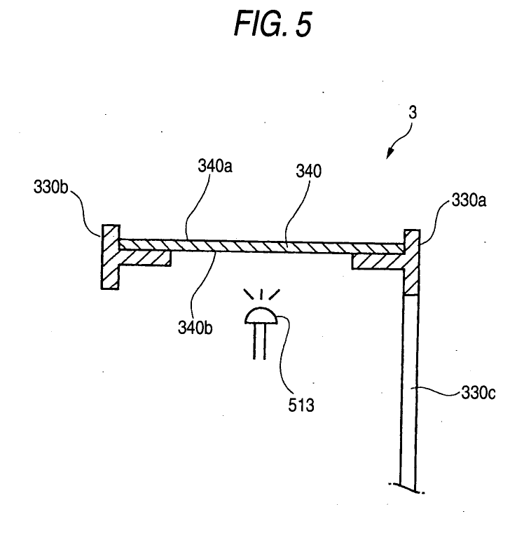

In FIGS. 4 and 5, the reel wheel 330 is made up of a first annular rim 330a to which one side of the reel belt 340 is attached, a second annular rim 330b to which an opposite side of the reel belt 340 is attached, arms 330c for supporting the first rim 330a, and a boss 330d of an attachment part for attaching the reel wheel 330 to the bracket 311.

The reel wheel 330 in the embodiment is formed with the whole (first rim 330a, second rim 330b, arms 330c, and boss 330d) made transparent. Polycarbonate is used as the material of the reel wheel 330 in the embodiment. The reel belt 340 is bonded so that it is sandwiched between the first rim 330a and the second rim 330b on both sides of the reel belt 340. In the reel wheel 330 in the embodiment, the first rim 330a and the second rim 330b are not directly jointed and are connected through the reel belt 340.

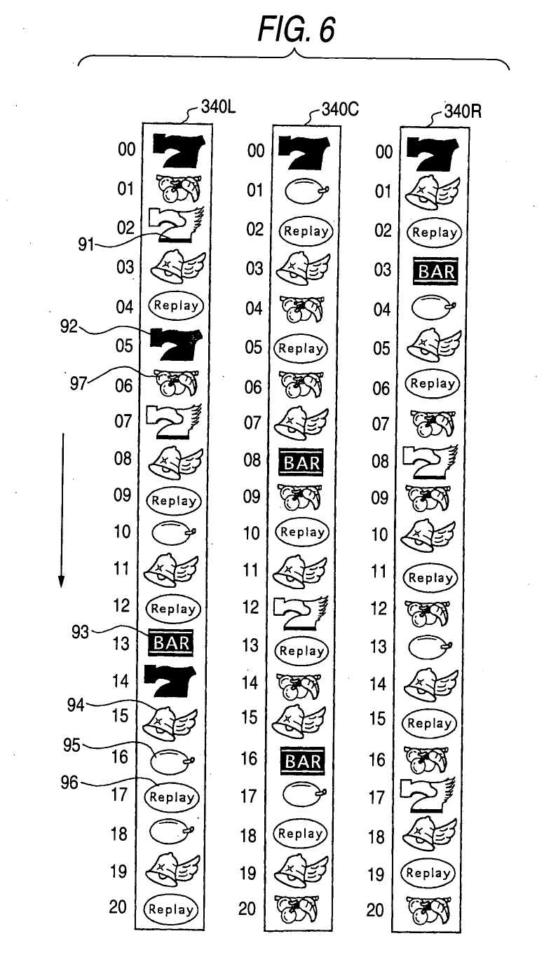

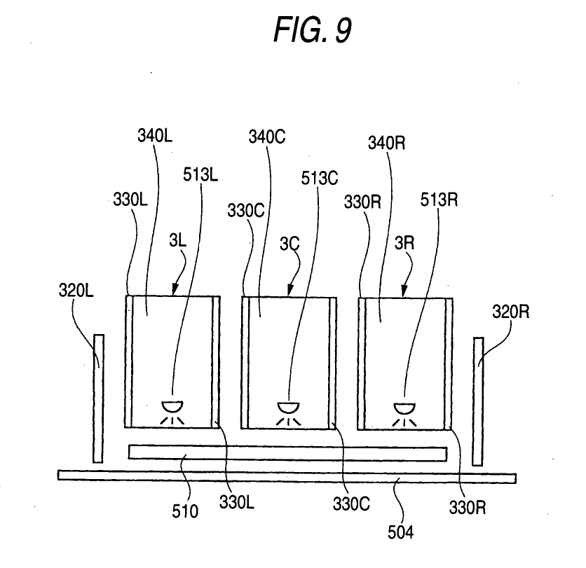

FIG. 6 shows the reel belts 340L, 340C, and 340R on which symbol rows each made up of 21 symbols are printed. The symbols are given code numbers 00 to 20 and are stored in ROM 32 (shown in FIG. 9) described later as a data table. The symbol rows each made up of symbols of “blue 7 (symbol 91),” “red 7 (symbol 92),” “BAR (symbol 93),” “bell (symbol 94),” “plum (symbol 95),” “Replay (symbol 96),” and “cherry (symbol 97)” are represented on the reel belts 340L, 340C, and 340R. The symbol rows on the reel belts 340L, 340C, and 340R are rotated so as to move in the arrow direction in FIG. 6 for producing variable display means of the symbol rows. The symbols may be printed on an outer peripheral surface 340a of the reel belt 340 shown in FIG. 5 or may be printed on an inner peripheral surface 340b of the reel belt 340. The portion of each symbol may be formed with asperities.

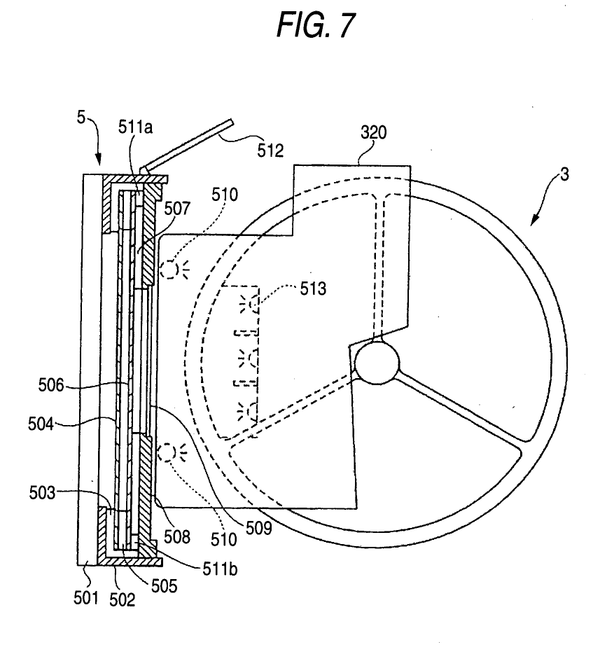

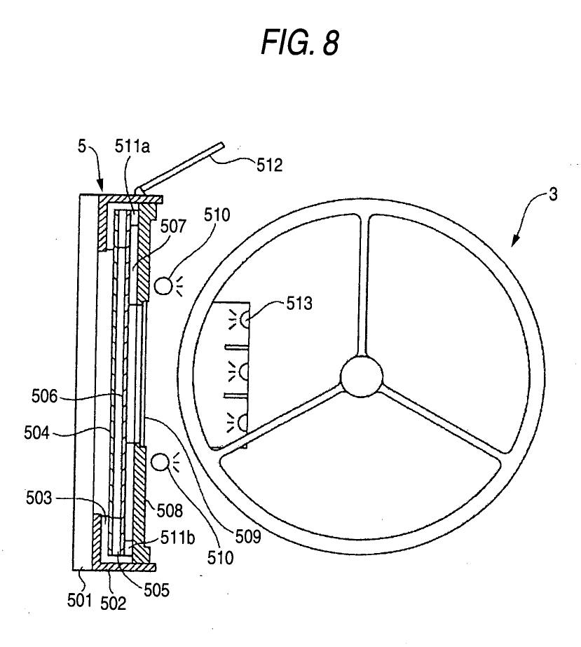

The configuration of the liquid crystal display 5 is as shown in FIG. 7. FIG. 8 shows a state in which the reel side reflectors 320 are removed. In FIGS. 7 and 8, a transparent acrylic plate 501 is provided on the front of the liquid crystal display 5, followed by a reel glass base 502, a bezel metal frame 503, liquid crystal 504, a liquid crystal holder 505, a diffuser sheet 506, a light guide plate 507, a rear holder 508, and an antistatic sheet 509 which are stacked in order. A display driver 512 is disposed in the upper part of the liquid crystal display 5 for driving the liquid crystal 504 to display an image on the liquid crystal 504. The antistatic sheet 509 prevents dusts from being deposited on the portion corresponding to the reel window (display window).

The light guide plate 507 is a plate material subjected to special treatment (containing laser beam machining) to uniformly reflect light on the back of a plate member such as an acrylic plate. The light guide plate 507 receives light of cold-cathode tube 511a, 511b used as liquid crystal backlight from the end face, reflecting the light on the rear, and producing uniform surface light emission. The light guide plate 507 and the rear holder 508 are formed with vertically oriented rectangular display windows (4L, 4C, and 4R in FIG. 2). The display windows 4L, 4C, and 4R are visually observed through the liquid crystal display 5. Specifically, the symbols on the reels 3 are seen through the liquid crystal 504 within the frames of the display windows 4L, 4C, and 4R.

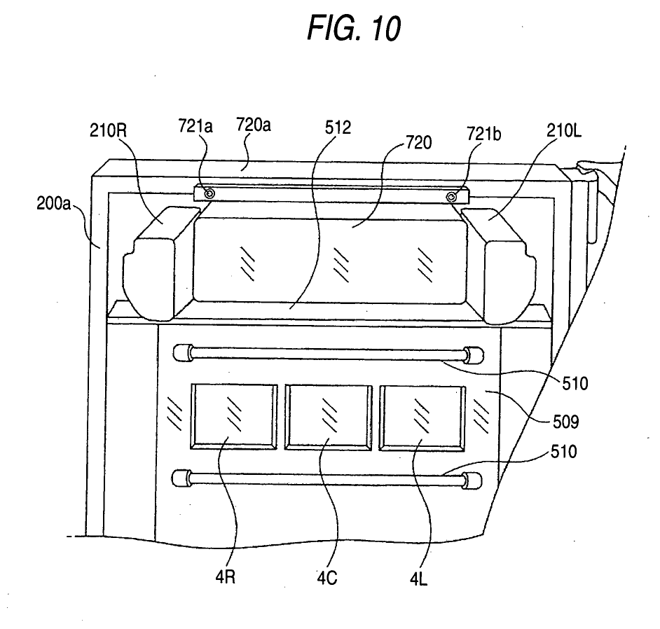

The cold-cathode tubes 511a and 511b are used as liquid crystal backlights for areas outside the frames of the display windows 4L, 4C, and 4R through the light guide plate 507. In contrast, three longitudinally arranged reel backlights 513 provided for each reel 3 are used as liquid crystal backlights for areas within the frames of the display windows 4L, 4C, and 4R. Two fluorescent lamps 510 disposed above and below the row of the display windows 4L, 4C, and 4R are also used as liquid crystal backlights for areas within the frames of the display windows 4L, 4C, and 4R, as also shown in FIG. 10 Further, the reel side reflectors 320 disposed on the sides of the reels 3 reflect light emitted from the reel backlights 513 and light emitted from the fluorescent lamps 510, and the light reflected by the reel side reflectors 320 is also applied to the liquid crystal in the areas within the frames of the display windows 4L, 4C, and 4R for illuminating the area. Particularly, each reel side reflector 320 is disposed along the triangular region in the gap between the reel 3 and the liquid crystal display 5. The length of the side of the reel side reflector 3 opposed to the liquid crystal display 5 is longer than the longitudinal length of the display window 4L, 4C, 4R and is longer than the spacing between the two fluorescent lamps 510.

FIG. 9 shows the positional relationships among the reels 3L, 3C, and 3R, the liquid crystal 504, the fluorescent lamp 510, the reel backlights 513L, 513C, and 513R, and the reel side reflectors 320L and 320R viewed from above. Specifically, the reel backlights 513L, 513C, and 513R illuminate the symbols on the reels 3L, 3C, and 3R from behind and also illuminate the areas within the frames of the display windows 4L, 4C, and 4R of the liquid crystal 504. The fluorescent lamps 510 illuminate the symbols on the reels 3L, 3C, and 3R from the slanting top and bottom of the front and also illuminate the liquid crystal in the areas within the frames of the display windows 4L, 4C, and 4R of the liquid crystal 504. Further, the reel side reflectors 320L and 320R reflect the light emitted from the reel backlights 513L, 513C, and 513R and the light emitted from the fluorescent lamps 510 for illuminating the symbols on the reels 3L, 3C, and 3R from the sides and also illuminating the liquid crystal in the areas within the frames of the display windows 4L, 4C, and 4R of the liquid crystal 504. The reel wheels 330L, 330C, and 330R made transparent for transmitting the light emitted from the reel backlights 513L, 513C, and 513R, and the light passing through the reel wheels 330L, 330C, and 330R arrives at the liquid crystal 504.

Therefore, the images displayed in the areas within the frames of the display windows 4L, 4C, and 4R of the liquid crystal 504 are sharply displayed owing to the light arriving through the symbol rows (reel belts) on the reels 3L, 3C, and 3R from the reel backlights 513, the light arriving directly from the fluorescent lamps 510, the light arriving after reflected on the reel side reflectors 320L and 320R, and the light arriving after reflected on the symbol rows (reel belts) on the reels 3L, 3C, and 3R. The light emitted from the reel backlights 513L, 513C, and 513R passes through the reel wheels 330L, 330C, and 330R and arrives at the liquid crystal 504, so that an image is sharply displayed even at a position where the shadow of the reel wheel 330L, 330C, 330R is cast within the frame of the display window 4L, 4C, 4R of the liquid crystal 504.

Hereinafter, the components involved in operation of the pinball slot machine 1 will be discussed with FIG. 2. The display windows 4L, 4C, and 4R are formed with a top line 8b, a center line 8c, and a bottom line 8d in the horizontal direction and a cross down line 8a and cross up line 8e in the slanting directions as pay lines. As the pay lines, one, three, or five lines are made activated as the player operates a 1-BET switch 11, a 2-BET switch 12, or a MAX-BET switch 13 (described later) or inserts medals into a medal insertion slot 22. Which pay lines are made activated is indicated as a BET lamp 9a, 9b, or 9c (described below) is lighted.

The 1-BET lamp 9a, the 2-BET lamp 9b, the MAX-BET lamp 9c, and a credit display unit 19 are provided on the left of the display windows 4L, 4C, and 4R. The 1-BET lamp 9a, the 2-BET lamp 9b, or the MAX-BET lamp 9c is lighted in response to the number of medals bet to play one game, which will be hereinafter referred to as the BET count.

In the embodiment, one game is over when all reels stop. When the BET count is 1 and one pay line is made activated, the 1-BET lamp 9a is lighted; when the BET count is 2 and three pay lines are made activated, the 2-BET lamp 9b is lighted; and when the BET count is 3 and all the five pay lines are made activated, the MAX-BET lamp 9c is lighted. The credit display unit 19 is made up of seven-segment LEDs for displaying the deposited number of medals.

The WIN lamp 17 and the payout display unit 18 are provided on the right of the display windows 4L, 4C, and 4R. The WIN lamp 17 is lighted when a specific winning game is complete. It is lighted at a predetermined probability when a specific internal winning is accepted. The payout display unit 18 is made up of seven-segment LEDs for displaying the number of medals paid out when the winning game is complete.

The bonus game information display unit 20 is provided in the upper right corner of the display screen 5a of the panel display unit 2a. The bonus game information display unit 20 is made up of seven-segment LEDs for displaying the number of times a predetermined game can be played, the possible number of times a specific game can be won.

As also shown in FIG. 1, a frontward projection portion 10 of a horizontal plane is formed below the display screen 5a. The display screen 5a displays not only the various lamps and the various display units, but also various effects of animation and the “operation order” required for realizing completion of the win when a predetermined internal winning is accepted.

The medal insertion slot 22 is provided at the right end of the frontward projection portion 10, and the 1-BET switch 11, the 2-BET switch 12, and the MAX-BET switch 13 are provided at the left end of the frontward projection portion 10. The 1-BET switch 11 enables the player to bet one of the credited medals by one push operation on a game. The 2-BET switch 12 enables the player to bet two of the credited medals by one push operation on a game. The MAX-BET switch 13 enables the player to bet as many medals as the maximum number of medals that can be bet on a game by one push operation. As the player operates any of the BET switches, the corresponding pay lines are made activated as described above.

A C/P switch 14 for the player to switch between credit and payout of the medals obtained by playing games by pushbutton operation is provided on the left of the front of the frontward projection portion 10. As the C/P switch 14 is switched, medals are paid out from a medal payout opening 15 in a lower part of the front and are stored in a medal reception tray 16.

On the right of the C/P switch 14, a start lever 6 for rotating the reels for starting variable display of symbols in the display windows 4L, 4C, and 4R (starting a game) as the player operates the start lever 6 is attached so that it can be turned in a predetermined angle range.

The speakers 21L and 21R are provided on the upper left and right of the cabinet 2, and a payout table panel 23 for displaying winning symbol combination, the number of payout medals, and the like is provided between the two speakers 21L and 21R.

Three stop buttons (left stop button 7L, center stop button 7C, and right stop button 7R) as operation buttons contained in stop operation means for stopping rotation of the three reels 3L, 3C, and 3R are provided at the center of the front of the frontward projection portion 10 and below the display screen 5a.

In the embodiment, the stop operation performed by the player pushing the first stop button when all reels rotate is called “first stop operation,” the stop operation next performed by the player pushing the second stop button is called “second stop operation,” and the stop operation performed by the player pushing the third stop button following the second stop operation is called “third stop operation.”

Since the pinball slot machine of the embodiment is provided with the three stop buttons 7L, 7C, and 7R, there are six different operation orders of the stop buttons. Then, the operation orders are distinguished from each other as follows: The left stop button 7L is abbreviated to “left,” the center stop button 7C to “center,” and the right stop button 7R to “right.”

To indicate the operation order, the abbreviations of the stop buttons 7L, 7C, and 7R are listed from left to right in the stop operation order. For example, when the player operates the left stop button 7L as the first stop operation, the center stop button 7C as the second stop operation, and the right stop button 7R as the third stop operation, the operation order is indicated as “left center right.” In the embodiment, the six different operation orders of “left center right,” “left right center,” “center left right,” “center right left,” “right left center,” and “right center left” are available.

The configuration of a part of the rear of a door of the cabinet 2 is as shown in FIG. 10. In FIG. 10, a liquid crystal display control board 720a for controlling display of the liquid crystal display 5 is housed in a transparent resin case 720 and is attached to the rear of a door 200a of the cabinet 2 (a part of the cabinet), namely, an upper frame part of the door 200a with screws 721a, 721b. Liquid crystal display parts including an antistatic sheet 509 and a display driver 512 of the liquid crystal display 5 are disposed below the liquid crystal display control board 720a. Semitransparent covers 210L and 210R for covering speakers 21L and 21R are placed at the left and right of the resin case 720.

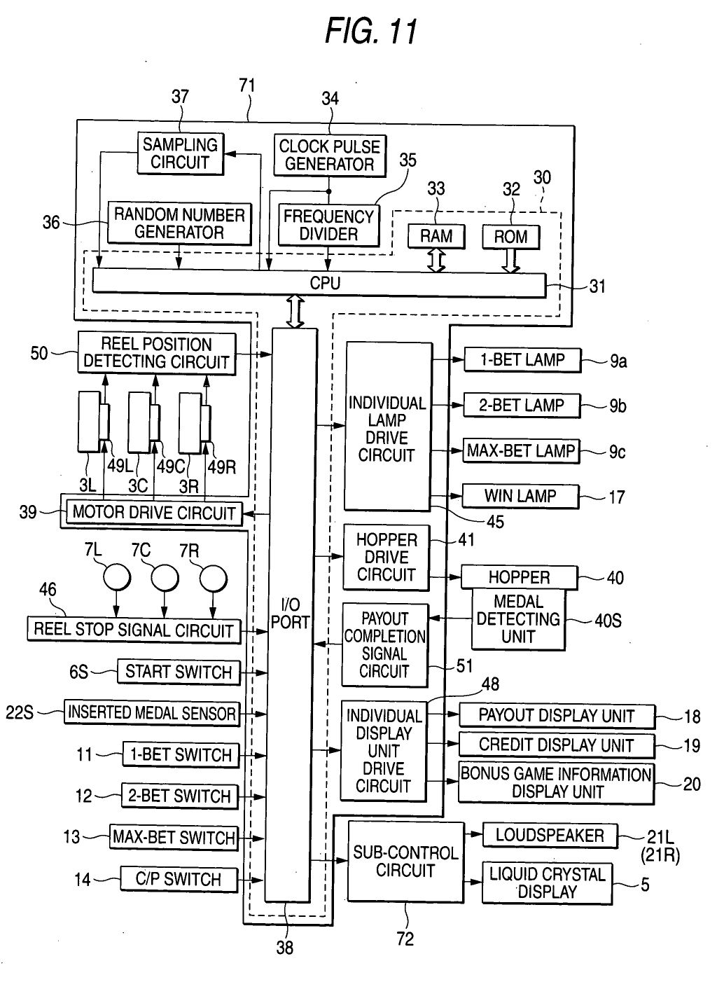

FIG. 11 shows the circuit configuration including the above-mentioned main control circuit 71 (contained in internal lottery means) for controlling the game processing operation of the pinball slot machine, peripherals (actuators) electrically connected to the main control circuit 71, and a sub-control circuit 72 (contained in control means) for controlling the liquid crystal display 5 and the speakers 21L and 21R based on a control command transmitted from the main control circuit 71.

The main control circuit 71 is made up of the microcomputer 30 placed on the circuit board as the main component and a random number sampling circuit. The microcomputer 30 includes a CPU 31 for performing the control operation in accordance with a preset program, and ROM 32 and RAM 33, both of which are provided as a storage.

Connected to the CPU 31 are a clock pulse generation circuit 34 for generating a reference clock pulse, a frequency divider 35, a random number generator 36 for generating sampled random numbers, and a sampling circuit 37.

For sampling random numbers, random number sampling may be executed in the microcomputer 30, namely, the operation program of the CPU 31. In this case, the random number generator 36 and the sampling circuit 37 can be omitted or can also be left for backup of the random number sampling operation.

The ROM 32 of the microcomputer 30 stores probability lottery tables used to determine random number sampling performed each time the player operates the start lever 6 (start operation), stop control tables for determining the reel stop mode in response to operation of the stop buttons, various control commands to be transmitted to the sub-control circuit 72.

The sub-control circuit 72 does not input commands and information to the main control circuit 71 and one-way communications are conducted from the main control circuit 71 to the sub-control circuit 72.

In the circuitry shown in FIG. 11, the main actuators whose operation is controlled by a control signal from the microcomputer 30 include the various lamps (1-BET lamp 9a, 2-BET lamp 9b, MAX-BET lamp 9c, and WIN lamp 17), the various display units (payout display unit 18, credit display unit 19, and bonus game information display unit 20), a hopper (containing a drive section for paying out medals) 40 as game play value giving means for storing medals and paying out a predetermined number of medals according to an instruction of a hopper drive circuit 41, and stepping motors 49L, 49C, and 49R for rotating the reels 3L, 3C, and 3R.

Further, a motor drive circuit 39 for driving and controlling the stepping motors 49L, 49C, and 49R, a hopper drive circuit 41 for driving and controlling the hopper 40, an individual lamp drive circuit 45 for driving and controlling the various lamps, and an individual display unit drive circuit 48 for driving and controlling the various display units are connected to the output section of the CPU 31 through an I/O port 38. Each of these drive circuits receives a control signal such as a drive command output from the CPU 31 and controls the operation of the corresponding actuator.

The main input signal generation means for generating an input signal required for generating a control command by the microcomputer 30 include a start switch 6S, the 1-BET switch 11, the 2-BET switch 12, the MAX-BET switch 13, the C/P switch 14, an inserted medal sensor 22S, a reel stop signal circuit 46, a reel position detecting circuit 50, and a payout completion signal circuit 51. These are also connected to the CPU 31 through the I/O port 38.

The start switch 6S detects the player operating the start lever 6. The inserted medal sensor 22S detects a medal inserted to the medal insertion slot 22. The reel stop signal circuit 46 generates a stop signal as the player operates each stop button 7L, 7C, 7R. The reel position detecting circuit 50 receives a pulse signal from a reel rotation sensor and supplies a signal for detecting the position of each reel 3L, 3C, 3R to the CPU 31. The payout completion signal circuit 51 generates a signal for detecting completion of medal payout when the count of a medal detection unit 40S (the number of medals payout from the hopper 40) reaches the specified number of medals.

In the circuitry in FIG. 11, the random number generator 36 generates random numbers contained in a given numeric value range and the sampling circuit 37 samples one random number at the appropriate timing after the player starts the start lever 6. The CPU 31 determines the internal winning combination based on the random number thus sampled and the probability lottery table stored in the ROM 32. Therefore, the CPU 31 implements winning state determination means for determining the winning state of the game, namely, the internal winning combination by random number lottery.

After rotation of each of the reels 3L, 3C, and 3R is started, the number of drive pulses supplied to each of the stepping motors 49L, 49C, and 49R and the counts are written into a predetermined area of the RAM 33. A reset pulse is obtained every revolution of the reel 3L, 3C, 3R and the reset pulses are input to the CPU 31 through the reel position detecting circuit 50. The drive pulse counts written in the RAM 33 are cleared to “0” according to the reset pulses thus obtained. Accordingly, the counts corresponding to the rotation positions of the reels 3L, 3C, and 3R within the range of one revolution are stored in the RAM 33.

A symbol table is stored in the ROM 32 to relate the rotation positions of the reels 3L, 3C, and 3R and the symbols drawn on the outer peripheral surfaces of the reels to each other. In the symbol table, the code numbers given in sequence every given rotation pitch of each reel 3L, 3C, 3R based on the rotation position where the reset pulse is generated and the symbol codes indicating the symbols provided in one-to-one correspondence with the code numbers are related to each other.

Further, a winning symbol combination table is stored in the ROM 32. The winning symbol combination table lists the symbol combinations of winning games, the numbers of payout medals for the winning games, and the winning game determination codes representing the winning games in association with each other. The winning symbol combination table is referenced at the stop control time of the left reel 3L, the center reel 3C, the right reel 3R and when the winning game is confirmed after all reels are stopped.

If the internal winning is accepted according to lottery processing based on the random number sampling (probability lottery processing), the CPU 31 sends the stop control signal of the reels 3L, 3C, and 3R to the motor drive circuit 39 based on the operation signal sent from the reel stop signal circuit 46 at the timing at which the player operates the stop buttons 7L, 7C, and 7R, and the selected stop control table. The CPU 31 functions as stop control means for performing stop control of the reels 3L, 3C, and 3R.

When the player pushes the stop button 7L, 7C, 7R, the stop control table is referenced and is used to determine the stop position of the reel.

Specifically, when the player pushes the stop button 7L, 7C, 7R, the symbol positioned on the center line 8c on the reel corresponding to the operated stop button (specifically, the symbol whose center is positioned above the center line 8c and is nearest to the position of the center line 8c) is detected, the code number of the symbol (operation position) is collated with the stop control table, and the code number of the symbol to be stopped at the position of the center line 8c (stop position) is determined.

In the stop mode indicating completion of the win of internal winning combination, the CPU 31 supplies a payout command signal to the hopper drive circuit 41 for paying out a predetermined number of medals to the player from the hopper 40.

At the time, the medal detection unit 40S counts the number of medals payout from the hopper 40. When the count reaches the specified number of medals, a medal payout completion signal is input to the CPU 31, which then stops driving the hopper 40 through the hopper drive circuit 41 and terminates the medal payout processing.

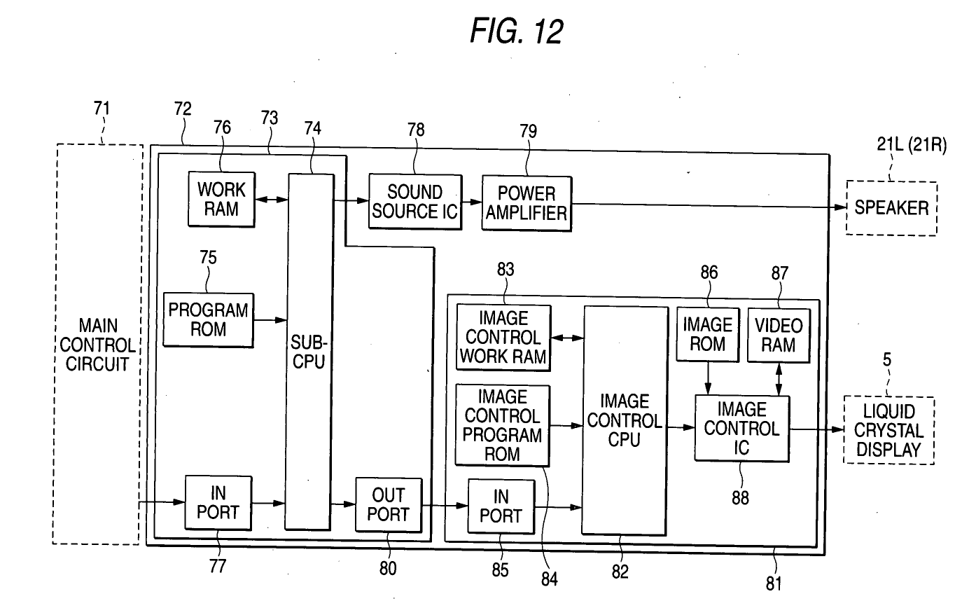

FIG. 12 shows the configuration of the sub-control circuit 72. The sub-control circuit 72 performs display control of the liquid crystal display 5 and output control of sound from the speakers 21L and 21R based on the control commands from the main control circuit 71. The sub-control circuit 72, which is implemented on a separate circuit board from the circuit board implementing the main control circuit 71, is made up of a microcomputer (sub-microcomputer) 73 as the main component, an image control circuit 81 as display control means of the liquid crystal display 5, a sound source IC 78 for controlling sound output from the speakers 21L and 21R, and a power amplifier 79.

The sub-microcomputer 73 includes a sub-CPU 74 for performing the control operation following a control command transmitted from the main control circuit 71, program ROM 75 as a storage, and work RAM 76. The signal from the main control circuit 71 to the sub-microcomputer 73 is input through an IN port 77, and the signal to the image control circuit 81 is output through an OUT port 80.

The sub-control circuit 72 does not include a clock pulse generation circuit, a frequency dividers a random number generator, or a sampling circuit, but executes random number sampling in an operation program of the sub-CPU 74. Generation of the assistance time period is determined as the random number sampling is executed.

The sub-CPU 74 includes the number-of-AT-sets counter and a number-of-AT-games counter. The number-of-AT-sets counter stores the number of sets. The number-of-AT-games counter stores information concerning the number of games in one assistance time period.

The program ROM 75 stores a control program executed in the sub-CPU 74. The work RAM 76 is used as a temporary storage for the sub-CPU 74 to execute the control program.

The image control circuit 81 is made up of an image control CPU 82, an image control work RAM 83, image control program ROM 84, image ROM 86, video RAM 87, and an image control IC 88. The image control CPU 82 determines the display contents on the liquid crystal display 5 in accordance with an image control program stored in the image control program ROM 84 based on the parameters set in the sub-microcomputer 73. The signal from the sub-CPU 74 is input through an IN port 85.

The image control program ROM 84 stores the image control program involved in display on the liquid crystal display 5 and various selection tables. The image control work RAM 83 is used as a temporary storage for the image control CPU 82 to execute the image control program. The image control IC 88 forms an image responsive to the display contents determined by the image control CPU 82 and outputs the image to the liquid crystal display 5. The image ROM 86 stores dot data for forming an image. The video RAM 87 is used as a temporary storage for the image control IC 88 to form an image.

The sub-CPU 74 displays an image on the liquid crystal display 5 based on the command signal from the CPU 31.

Specifically, whenever a stop signal is input from the reel stop signal circuit 46 as the player operates the start lever 6 or the stop button 7L, 7C, 7R, the sub-CPU 74 transmits a signal to the image control CPU 82 and displays an image on the display screen 5a of the liquid crystal display 5.

The effect image displayed on the liquid crystal display 5 by the image control CPU 82 is displayed only outside the frame of the display window 4 for allowing the player to visually check the symbols on the reel 3 within the frame of the display window 4 at times; the effect image is also displayed within the frame of the display window 4 for allowing the player to visually check the symbols on the reel 3 within the frame of the display window 4 at times; or the effect image is displayed so as to cover all the symbols on the reel 3 within the frame of the display window at times. Therefore, the player can visually check the symbols on the reel 3 clearly within the frame of the display window 4 and can also visually check the effect image displayed over the full face of the rectangular 15-inch liquid crystal screen.

As described above, the gaming machine of the first embodiment of the invention includes a plurality of reel belts 340 (contained in symbol strips) each on which a plurality of symbols are placed, a plurality of reel wheels 330, particularly the rims 330a and 330b (contained in annular bodies) to which the reel belts 340 are attached annularly, the liquid crystal 504 (contained in image display means) being provided in front of the reel wheels 330 for displaying an image concerning game play, and the reel backlights 513 (contained in light source) for illuminating the symbols on the reel belts 340 from behind the symbols, wherein the reel wheels 330, particularly the rims 330a and 330b are made transparent or semitransparent for transmitting light from the reel backlights 513 in the direction of the liquid crystal 504. Thus, the light from the reel backlight 513 passes through the reel wheel 330 and arrives at the liquid crystal 504, so that an image is sharply displayed even at a position where the shadow of the reel wheel 330 is cast, and the shadow of the reel wheel 330 is not cast over the image, enabling the player to clearly visually check the image and enjoy playing a game.

In the description of the embodiment, the reel wheel 330 is formed of polycarbonate which has good transparency and good shock resistance and can be molded at a low cost. In the invention, however, the reel wheel 330 may be formed of PMMA (polymethyl methacrylate), PET (polyethylene terephthalate), or any other translucent member.

In the description of the embodiment, the whole of the reel wheel 330 is made transparent. In the invention, however, if only the first and second annular rims 330a and 330b of the reel wheel 330 are made transparent, similar advantages can be provided.

In the description of the embodiment, the reel wheel 330 is made transparent. In the invention, however, the reel wheel 330 may be made translucent like the reel belt 340 or may be made semitransparent. Particularly, if the reel wheel 330 is made white, it is preferable because white allows the player to perceive color development of liquid crystal.

Second Embodiment

In a second embodiment of the invention, the reel wheel 330, particularly the rims 330a and 330b shown in FIGS. 3 through 5 are made semitransparent for transmitting light emitted from reel backlight 513 and the reel wheel 330, particularly the rims 330a and 330b are also formed so as to have diffusibility for diffusing the light emitted from the reel backlight 513. For example, the reel wheel 330 is formed of white paint containing fine particles provided with diffusibility, mixed with carbonate. Other components are similar to those in the first embodiment.

The gaming machine of the second embodiment of the invention includes a plurality of reel belts 340 (contained in symbol strips) each on which a plurality of symbols are placed, a plurality of reel wheels 330, particularly the rims 330a and 330b (contained in annular bodies) to which the reel belts 340 are attached annularly, the liquid crystal 504 (contained in image display means) being provided in front of the reel wheels 330 for displaying an image concerning game play, and the reel backlights 513 (contained in light source) for illuminating the symbols on the reel belts 340 from behind the symbols, wherein the reel wheels 330, particularly the rims 330a and 330b are formed so as to diffuse light from the reel backlight 513 in the direction of the liquid crystal 504. Thus, the light from the reel backlight 513 is diffused through the reel wheel 330, particularly the rims 330a and 330b and arrives at the liquid crystal 504; the shadow of the reel wheel 330 is not cast over the image and the light from the reel wheel 330 is not highlighted either, enabling the player to clearly visually check the essential image and enjoy playing a game.

Third Embodiment

In a third embodiment of the invention, the reel wheel 330, particularly the rims 330a and 330b shown in FIGS. 3 through 5 are formed so as to reflect light from fluorescent lamps 510 shown in FIGS. 7 through 10. For example, each reel 3 is formed of white paint provided with reflectivity, mixed with carbonate. Other components are similar to those in the first embodiment.

The gaming machine of the third embodiment of the invention includes a plurality of reel belts 340 (contained in symbol strips) each on which a plurality of symbols are placed, a plurality of reel wheels 330, particularly the rims 330a and 330b (contained in annular bodies) to which the reel belts 340 are attached annularly, the liquid crystal 504 (contained in image display means) being provided in front of the reel wheels 330 for displaying an image concerning game play, and the fluorescent lamps 510 (contained in light source) for illuminating the symbols on the reel belts 340 from the slanting direction of a front of the symbols, wherein the reel wheels 330, particularly the rims 330a and 330b are formed so as to reflect light from the fluorescent lamps 510 in the direction of the liquid crystal 504. Thus, the light from the fluorescent lamps 510 is reflected on the reel wheel 330, particularly the rims 330a and 330b and arrives at the liquid crystal 504, and the shadow of the reel wheel 330 is not cast over the image, enabling the player to clearly visually check the image and enjoy playing a game.

In the first embodiment, the reel wheel 330 transmits the light from the reel backlight 513 in the direction of the liquid crystal 504; in the second embodiment, the reel wheel 330 diffuses the light from the reel backlight 513 in the direction of the liquid crystal 504; and in the third embodiment, the reel wheel 330 reflects the light from the fluorescent lamp 310 in the direction of the liquid crystal 504. However, passing through, diffusing, and reflecting the light in the direction of the liquid crystal 504 may be all performed or any two of passing through, diffusing, and reflecting the light in the direction of the liquid crystal 504 may be performed in combination.

Fourth Embodiment

In a fourth embodiment of the invention, a reel 3 is formed in one piece unlike the reel 3 in the first embodiment made up of the reel belt (340 in FIG. 4) on which a plurality of symbols are arranged and the reel wheel (330 in FIG. 4) around which the reel belt is wound as separate parts.

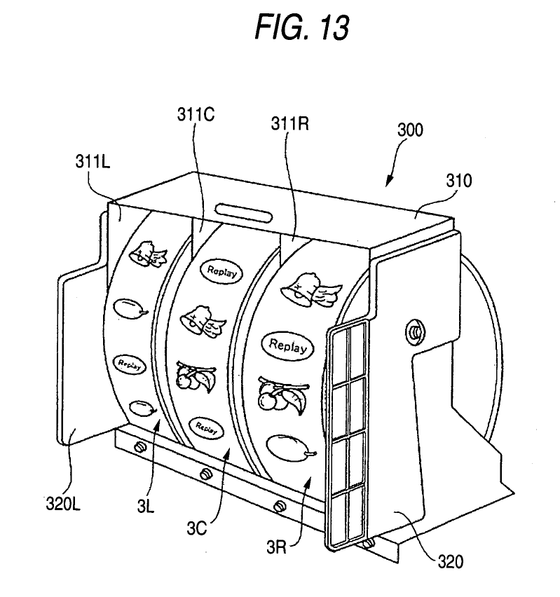

Specifically, each of three reels (3L, 3C, 3R) shown in FIGS. 2 and 13 is made up of an annular rim 350e on which a plurality of symbols are placed, arms 350c for supporting the rim 350e, and a boss 350d of an attachment part for attaching the reel to a bracket 311 (311L, 311C, 311R) in FIG. 13, the rim 350e, the arms 350c, and the boss 350d being formed in one piece.

The reel (3L, 3C, 3R) is made semitransparent in white. Therefore, in the embodiment, the rim 350e on which a plurality of symbols are placed, particularly both side ends of an outer peripheral surface 350f of the rim 350e and nearby side margins 350a and 350b are made semitransparent in white, and light of a reel backlight 513 for illuminating the symbols from behind the symbols is not blocked by the side margin 350a, 350b of the rim 350e and arrives at liquid crystal 504. Specifically, the reel 3 is formed of white paint mixed with carbonate.

The symbols may be printed on the outer peripheral surface 350f of the rim 350e or may be printed on an inner peripheral surface 350g of the rim 350e. The portion of each symbol may be formed with asperities.

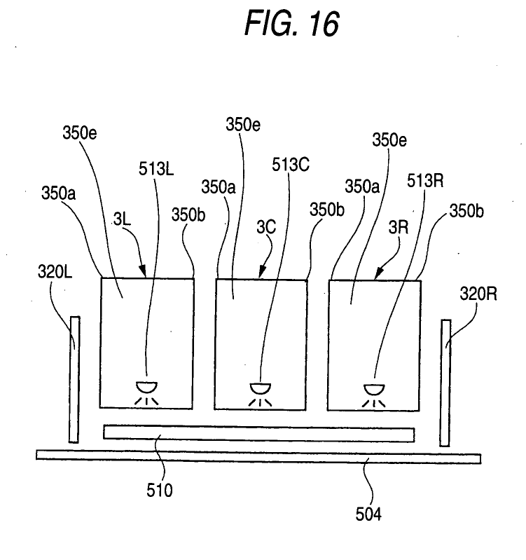

FIG. 16 shows the positional relationships among the reels 3L, 3C, and 3R, the liquid crystal 504, a fluorescent lamp 510, the reel backlights 513L, 513C, and 513R, and reel side reflectors 320L and 320R viewed from above. In FIG. 16, the rim 350e of the reel 3L, 3C, 3R made semitransparent, particularly the side margins 350a and 350b transmits the light emitted from the reel backlight 513L, 513C, 513R and the light passing through the side margins 350a and 350b arrives at the liquid crystal 504.

As described above, the gaming machine of the fourth embodiment of the invention includes a plurality of reels 3 (contained in annular bodies) each having a rim 350e (contained in outer ring part) on which a plurality of symbols are placed and the arms 350c (contained in arm part) joined to the rim 350e, the liquid crystal 504 (contained in image display means) being provided in front of the reels 3 for displaying an image concerning game play, and the reel backlights 513 (contained in light source) for illuminating the symbols from behind the symbols, wherein each of the reels 3 has the rim 350e and the arms 350c formed in one piece and at least the side margin (for example, 350a, 350b) of the rim 350e is made transparent or semitransparent for transmitting the light from the reel backlight 513 in the direction of the liquid crystal 504. Thus, the light from the reel backlight 513 passes through at least the side margin 350a, 350b of the rim 350e and arrives at the liquid crystal 504, so that an image is sharply displayed even at a position where the shadow of the side margin 350a, 350b of the rim 350e of the reel 3 is cast, and the shadow is not cast over the image, enabling the player to clearly visually check the image and enjoy playing a game.

In the description of the embodiment, the rim 350 and the arms 350c of the reel 3 are made semitransparent in white. In the invention, however, the side margins 350a and 350b of the rim 350e may be transparent and the outer peripheral surface 350f of the rim 350e may be semitransparent in white. For example, the whole of the reel 3 (containing the rim 350e and the arms 350c) may be formed of transparent carbonate and the outer peripheral surface 350f of the rim 350e may be painted with white semitransparent paint and then color symbols may be printed on the outer peripheral surface 350f of the rim 350e with white on the base.

Fifth Embodiment

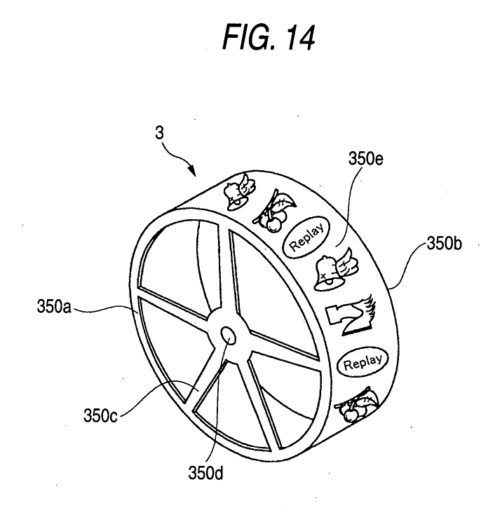

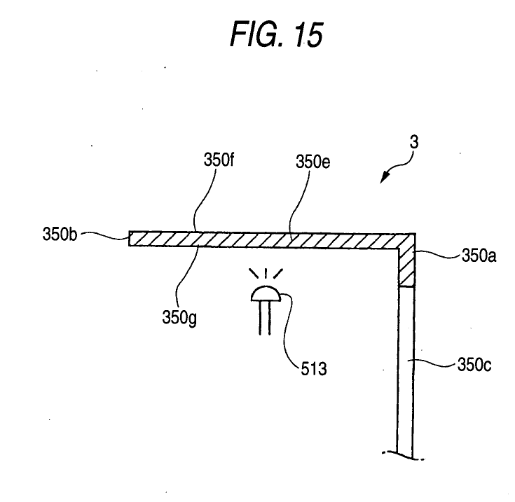

In a fifth embodiment of the invention, the rim 350e of the reel 3 shown in FIGS. 14 and 15, particularly the side margins 350a and 350b are made semitransparent in white for transmitting light emitted from reel backlight 513 and the rim 3, particularly the side margins 350a and 350b are also formed so as to have diffusibility for diffusing the light emitted from the reel backlight 513. For example, the reel 3 is formed of white paint containing fine particles provided with diffusibility, mixed with carbonate. Other components are similar to those in the fourth embodiment.

The gaming machine of the fifth embodiment of the invention includes a plurality of reels 3 (contained in annular bodies) each having a rim 350e (contained in outer ring part) on which a plurality of symbols are placed and the arms 350c (contained in arm part) joined to the rim 350e, the liquid crystal 504 (contained in image display means) being provided in front of the reels 3 for displaying an image concerning game play, and the reel backlights 513 (contained in light source) for illuminating the symbols from behind the symbols, wherein each of the reels 3 has the rim 350e and the arms 350c formed in one piece and at least the side margin (for example, 350a, 350b) of the rim 350e is formed so as to diffuse the light from the reel backlight 513 in the direction of the liquid crystal 504. Thus, the light from the reel backlight 513 is diffused at least in the side margin of the rim 350e and arrives at the liquid crystal 504, so that the shadow is not cast over the image, enabling the player to clearly visually check the image and enjoy playing a game.

Sixth Embodiment

In a sixth embodiment of the invention, the rim 350e of the reel 3 shown in FIGS. 14 and 15, particularly the side margins 350a and 350b are formed so as to reflect light of the fluorescent lamps 510 shown in FIGS. 7 through 11. And, the rim 3, particularly the side margins 350a and 350b are formed so as to reflect light of the fluorescent lamps 510. For example, the reel 3 is formed of white paint provided with reflectivity, mixed with carbonate. Other components are similar to those in the fifth embodiment.

The gaming machine of the sixth embodiment of the invention includes a plurality of reels 3 (contained in annular bodies) each having a rim 350e (contained in outer ring part) on which a plurality of symbols are placed and the arms 350c (contained in arm part) joined to the rim 350e, the liquid crystal 504 (contained in image display means) being provided in front of the reels 3 for displaying an image concerning game play, and the fluorescent lamps 510 (contained in light source) for illuminating the symbols from the slanting direction of a front of the symbols, wherein each of the reels 3 has the rim 350e and the arms 350c formed in one piece and at least the side margin (for example, 350a, 350b) of the rim 350e is formed so as to reflect the light from the fluorescent lamp 510 in the direction of the liquid crystal 504. Thus, the light from the fluorescent lamp 510 is reflected at least on the side margin of the rim 350e and arrives at the liquid crystal 504, so that the shadow is not cast over the image, enabling the player to clearly visually check the image and enjoy playing a game.

In the fourth embodiment, the rim 350e of the reel 3 transmits the light from the reel backlight 513 in the direction of the liquid crystal 504; in the fifth embodiment, the rim 350e of the reel 3 diffuses the light from the reel backlight 513 in the direction of the liquid crystal 504; and in the sixth embodiment, the rim 350e of the reel 3 reflects the light from the fluorescent lamp 310 in the direction of the liquid crystal 504. However, passing through, diffusing, and reflecting the light in the direction of the liquid crystal 504 may be all performed or any two of passing through, diffusing, and reflecting the light in the direction of the liquid crystal 504 may be performed in combination.

As described above, according to the invention, the gaming machine for making it possible to prevent the shadow of each reel from being cast over the image and enabling the player to clearly visually check the essentially image and enjoy playing a game can be provided.

Although only some exemplary embodiments of the invention have been described in detail above, those skilled in the art will readily appreciate that many modifications are possible in the exemplary embodiments without materially departing from the novel teachings and advantages of the invention. Accordingly, all such modifications are intended to be included within the scope of the invention.

This application is related to co-pending U.S. patent applications entitled “GAMING MACHINE” referred to as Attorney Docket No. SHO-0019, “GAMING MACHINE” referred to as Attorney Docket No. SHO-0020, “GAMING MACHINE” referred to as Attorney Docket No. SHO-0021, “GAMING MACHINE” referred to as Attorney Docket No. SHO-0022, “GAMING MACHINE” referred to as Attorney Docket No. SHO-0023, “GAMING MACHINE” referred to as Attorney Docket No. SHO-0024, “GAMING MACHINE” referred to as Attorney Docket No. SHO-0025, “GAMING MACHINE” referred to as Attorney Docket No. SHO-0026, “GAMING MACHINE” referred to as Attorney Docket No. SHO-0027, “GAMING MACHINE” referred to as Attorney Docket No. SHO-0028, “GAMING MACHINE” referred to as Attorney Docket No. SHO-0029, “GAMING MACHINE” referred to as Attorney Docket No. SHO-0030, “GAMING MACHINE” referred to as Attorney Docket No. SHO-0031, “GAMING MACHINE” referred to as Attorney Docket No. SHO-0032, “GAMING MACHINE” referred to as Attorney Docket No. SHO-0033, “GAMING MACHINE” referred to as Attorney Docket No. SHO-0034, “GAMING MACHINE” referred to as Attorney Docket No. SHO-0035, “GAMING MACHINE” referred to as Attorney Docket No. SHO-0036, “GAMING MACHINE” referred to as Attorney Docket No. SHO-0037, “GAMING MACHINE” referred to as Attorney Docket No. SHO-0038, “GAMING MACHINE” referred to as Attorney Docket No. SHO-0039, “GAMING MACHINE” referred to as Attorney Docket No. SHO-0040, “GAMING MACHINE” referred to as Attorney Docket No. SHO-0041, “GAMING MACHINE” referred to as Attorney Docket No. SHO-0042, “GAMING MACHINE” referred to as Attorney Docket No. SHO-0043, “GAMING MACHINE” referred to as Attorney Docket No. SHO-0044, “GAMING MACHINE” referred to as Attorney Docket No. SHO-0045, “GAMING MACHINE” referred to as Attorney Docket No. SHO-0046, “GAMING MACHINE” referred to as Attorney Docket No. SHO-0047, “GAMING MACHINE” referred to as Attorney Docket No. SHO-0048, “GAMING MACHINE” referred to as Attorney Docket No. SHO-0049, “GAMING MACHINE” referred to as Attorney Docket No. SHO-0050, “GAMING MACHINE” referred to as Attorney Docket No. SHO-0051, “GAMING MACHINE” referred to as Attorney Docket No. SHO-0052, “MOTOR STOP CONTROL DEVICE” referred to as Attorney Docket No. SHO-0053, “GAMING MACHINE” referred to as Attorney Docket No. SHO-0054, “GAMING MACHINE” referred to as Attorney Docket No. SHO-0055, “GAMING MACHINE” referred to as Attorney Docket No. SHO-0056, and “GAMING MACHINE” referred to as Attorney Docket No. SHO-0057, respectively, all the applications being filed on Oct. 31, 2003 herewith. The co-pending applications including specifications, drawings, and claims are expressly incorporated herein by reference in their entirety.

What is claimed is:

1. A gaming machine comprising:
a plurality of symbol strips each having a plurality of symbols;
a plurality of annular bodies to which each of the symbol strips are annularly attached;
image display means provided in front of the plurality of annular bodies and configured to display an image concerning a game; and
a light source configured to illuminate the symbols from behind the symbols,
wherein the plurality of annular bodies are made transparent or semitransparent for transmitting light from the light source in a direction of the image display means.

2. A gaming machine comprising:
a plurality of symbol strips each having a plurality of symbols;
a plurality of annular bodies to which each of the symbol strips are annularly attached;
image display means provided in front of the plurality of annular bodies and configured to display an image concerning a game; and
a light source configured to illuminate the symbols from behind the symbols,
wherein the plurality of annular bodies are formed to diffuse light from the light source in a direction of the image display means.

3. A gaming machine comprising:
a plurality of symbol strips each having a plurality of symbols;
a plurality of annular bodies to which each of the symbol strips are annularly attached;
image display means provided in front of the plurality of annular bodies and configured to display an image concerning a game; and
a light source configured to illuminate the symbols from a slanting direction of a front of the symbols,
wherein the plurality of annular bodies are formed to reflect light from the light source in a direction of the image display means.

4. A gaming machine comprising:
a plurality of annular bodies each having an outer ring part on which a plurality of symbols are placed, and an arm part joined to the outer ring part;
image display means provided in front of the plurality of annular bodies and configured to display an image concerning a game; and
a light source configured to illuminate the symbols from behind the symbols,
wherein the outer ring part and the arm part of each of the annular bodies are formed in one piece,
wherein at least a side margin of the outer ring part is made transparent or semitransparent for transmitting light from the light source in a direction of the image display means.

5. A gaming machine comprising:
a plurality of annular bodies each having an outer ring part on which a plurality of symbols are placed, and an arm part joined to the outer ring part;
image display means provided in front of the plurality of annular bodies and configured to display an image concerning a game; and
a light source configured to illuminate the symbols from behind the symbols,
wherein the outer ring part and the arm part of each of the annular bodies are formed in one piece,
wherein at least a side margin of the outer ring part is formed to diffuse light from the light source in a direction of the image display means.

6. A gaming machine comprising:
a plurality of annular bodies each having an outer ring part on which a plurality of symbols are placed, and an arm part joined to the outer ring part;
image display means provided in front of the plurality of annular bodies and configured to display an image concerning a game; and
a light source configured to illuminate the symbols from a slanting direction of a front of the symbols,
wherein the outer ring part and the arm part of each of the annular bodies are formed in one piece,
wherein at least a side margin of the outer ring part is formed to reflect light from the light source to diffuse in a direction of the image display means.

7. The gaming machine as claimed in claim 1, wherein the annular body is formed in white color.

8. The gaming machine as claimed in claim 1, wherein the annular body is formed of polycarbonate.
